(19) United States
(12) Patent Application Publication
(10) Pub. No.: US 2006/0059045 A1
(43) Pub. Date: Mar. 16, 2006

(54) Method and system for entertainment content distribution

(76) Inventors: Ashok Babbar, Fremont, CA (US); Weihong Zhang, Cupertino, CA (US)

Correspondence Address: FISH & RICHARDSON P.C., PO BOX 1022, MINNEAPOLIS, MN, 55440-1022, US

(21) Appl. No.: 10/941,544

(22) Filed: Sep. 14, 2004

(51) Int. Cl. G06Q 30/00

(52) U.S. Cl. 705/14

(57) ABSTRACT

Methods and systems for providing entertainment content to a consumer are described. An entertainment content unit is received from an entertainment content provider and multiple advertising content units are received from one or more advertising content providers. A modified entertainment content unit is generated including a set of advertising content units at multiple intervals within the entertainment content unit, and can be recorded on a recording medium. A request for the entertainment content unit is received from a consumer, and the consumer is provided with the modified entertainment content unit, for example, on the recording medium. The consumer does not provide monetary compensation for receipt of the modified entertainment content unit.

### TECHNICAL FIELD

This invention relates to entertainment content distribution.

### BACKGROUND

The affordability of video cassette recorders (VCRs) and digital video disc (DVD) players has increased the accessibility of entertainment content for at-home viewing considerably in the past couple of decades. Consumers are no longer limited to viewing entertainment content on television or at a movie theatre, but are presented with a vast choice of entertainment content selections that can be either purchased or rented for viewing at home with a VCR or DVD player.

Although videotapes and DVDs containing entertainment content, particularly fictional films, have become increasingly popular, some consumers may still be disinclined to purchase one as the cost can exceed twice the price of a ticket to view the film at a movie theatre. Renting is an option, but a consumer is limited to selections that are available when the consumer goes to a rental store to select a videotape or DVD, and must view the rented videotape or DVD within the typically short rental period. Online services are available, e.g., Netflix, Inc. at www.netflix.com, that allow a consumer to create a list of desired movies, and for a monthly fee, the consumer is provided with a limited number (e.g., 3 to 5) of movies from the movie list at a given time. The movies are provided on a DVD and are sent to the consumer by mail. Once the consumer is finished with the movie, the consumer mails the DVD back to the online service provider and is provided with a different movie from the consumer's movie list. Videotapes or DVDs often include lengthy sections of movie trailers at the beginning of the recording, which trailers may be considerably outdated by the time the consumer rents the videotape or DVD.

### SUMMARY

This invention relates to entertainment content distribution. In general, in one aspect, the invention features a system for providing entertainment content to a consumer. The system includes an entertainment content store, an advertising content store, a user interface, a generation engine and a delivery engine. The entertainment content store stores a plurality of entertainment content units received from one or more entertainment content providers. The advertising content store stores a plurality of advertising content units received from one or more advertising content providers. The user interface is operable to receive a request from a consumer for an entertainment content unit, the request identifying a first entertainment content unit stored in the entertainment content store. The generation engine is operable to generate a modified entertainment content unit by including a set of advertising content units at a plurality of intervals within the first entertainment content unit and recording the modified entertainment content unit on a recording medium. The delivery engine is operable to cause the recording medium to be delivered to the consumer. The consumer does not provide monetary compensation to the system for providing the modified entertainment content unit. The system provides monetary compensation to the entertainment content provider of the first entertainment content unit, and the one or more advertising content providers that provided the set of advertising content units provide compensation to the system based on the delivery of the modified entertainment content unit to the consumer.

Implementations can include one or more of the following features. The generation engine can be further operable to generate the modified entertainment content unit in response to the request from the consumer for the first entertainment content unit. One or more target audience groups can be associated with the first entertainment content unit, and one or more target audience groups can be associated with each of the plurality of advertising content units stored in the advertising store. The generation engine can be further operable to compare the one or more target audience groups associated with the first entertainment content unit to the one or more target audience groups associated with each of the plurality of advertising content units stored in the advertising store, and select the set of advertising content units to include within the first entertainment content unit based on the comparison.

The system can further include a registration engine operable to receive consumer profile information from the consumer, and a target audience group engine operable to associate one or more audience groups with the consumer based on the consumer profile information. The target audience group engine can associate one or more target audience groups with the plurality of advertising content units stored in the advertising store. The generation engine can be further operable to compare the one or more audience groups associated with the consumer to the one or more target audience groups associated with the plurality of advertising content units stored in the advertising store, and select the set of advertising content units to include within the entertainment content unit based on the comparison.

The user interface can be further operable to request feedback from the consumer about a previously delivered modified entertainment content unit and to receive the requested consumer feedback. The system can be operable to provide the consumer feedback to at least one of an entertainment content provider or an advertising content provider. The system can be further operable to compile consumer feedback received from a plurality of consumers and to provide the compiled consumer feedback to at least one of an entertainment content provider or an advertising content provider.

In general, in another aspect, the invention features a system for providing entertainment content to a consumer. The system includes a means for receiving an entertainment content unit from an entertainment content provider and a means for receiving a plurality of advertising content units from one or more advertising content providers. The system further includes a means for generating a modified entertainment content unit by including a set of advertising content units at a plurality of intervals within the entertainment content unit and a means for recording the modified entertainment content unit on a recording medium. A means for receiving a request for the entertainment content unit from a consumer is provided, as well as a means for providing the consumer with the modified entertainment content unit on the recording medium. The consumer does not provide monetary compensation to the system for providing the modified entertainment content unit, the system provides monetary compensation to the entertainment content provider of the first entertainment content unit, and the one or more advertising content providers that provided the set of advertising content units provide compensation to the system based on the delivery of the modified entertainment content unit to the consumer.

Implementations of the system can include one or more of the following features. The recording medium can be a digital video disc (DVD) or a video tape. The system can further include a means for associating one or more target audience groups with the entertainment content unit and a means for associating one or more target audience groups with each of the plurality of advertising content units. The means for generating the modified entertainment content unit can include a means for comparing the target audience groups associated with the entertainment content unit to the target audience groups associated with the plurality of units of advertising content units, and a means for selecting the set of advertising content units from the plurality of advertising content units based on the comparison.

A means for associating one or more target audience groups with the entertainment content unit can include a means for determining a genre for the entertainment content unit, and a means for associating the target audience groups based on the genre. A means for associating one or more target audience groups for the plurality of advertising content units can include a means for receiving an association of one or more target audience groups to each of the plurality of advertising content units from the one or more advertising content providers.

The system can further include a means for receiving from the consumer a consumer profile, a means for associating one or more audience groups with the consumer based on the consumer profile, and a means for associating one or more target audience groups with the plurality of advertising content units. The means for generating the modified entertainment content unit can include a means for comparing the audience groups associated with the consumer to the target audience groups associated with the plurality of advertising content units, and a means for selecting the set of advertising content units from the plurality of advertising content units based on the comparison.

The means for generating a modified entertainment content unit can include a means for detecting scene breaks within the entertainment content unit, and a means for including one or more advertising content units of the set of advertising content units after one or more scene breaks. Alternatively, the means for generating a modified entertainment content unit can include a means for including one or more advertising content units of the set of advertising content units after one or more predetermined time intervals of the entertainment content unit.

In general, in another aspect, the invention features a method including the steps of receiving an entertainment content unit from an entertainment content provider, receiving a plurality of advertising content units from one or more advertising content providers, and generating a modified entertainment content unit including a set of advertising content units at a plurality of intervals within the entertainment content unit. The modified entertainment content unit is recorded on a recording medium. A request for the entertainment content unit is received from a consumer, and the consumer is provided with the modified entertainment content unit on the recording medium.

Implementations of the invention can include one or more of the following features. The method can further include providing compensation to one of the entertainment content providers for the entertainment content unit, and receiving compensation from one or more advertising content provider for including a set of advertising content units in the modified entertainment content unit. The consumer is provided with the modified entertainment content unit on the recording medium at no monetary expense to the consumer.

Generating the modified entertainment content unit can be in response to receiving a request for the entertainment content unit from the consumer. The recording medium can be, for example, a digital video disc (DVD) or a video tape. The advertising content provider can be different from the entertainment content provider.

The method can further include associating one or more target audience groups with the entertainment content unit and associating one or more target audience groups with the plurality of advertising content units. Generating the modified entertainment content unit can include comparing the target audience groups associated with the entertainment content unit to the target audience groups associated with the plurality of advertising content units, and selecting the set of advertising content units from the plurality of advertising content units based on the comparison.

Associating one or more target audience groups with the entertainment content unit can include determining a genre for the entertainment content unit, and associating the target audience groups based on the genre. Associating one or more target audience groups with the plurality of advertising content units can include receiving an association of one or more target audience groups with each of the plurality of advertising content units from the one or more advertising content providers.

The method can further include receiving from the consumer a consumer profile, associating one or more audience groups to the consumer based on the consumer profile, and associating one or more target audience groups with the units of the plurality of advertising content units. Generating the modified entertainment content unit can include comparing the audience groups associated with the consumer to the target audience groups associated with the plurality of advertising content units, and selecting the set of advertising content units from the plurality of advertising content units based on the comparison.

Generating a modified entertainment content unit can include detecting scene breaks within the entertainment content unit, and including the one or more advertising content units of the set of advertising content units after a plurality of scene breaks. Alternatively, a modified entertainment content unit can be generated by including one or more advertising content units of the set of advertising content units after a plurality of predetermined time intervals of the entertainment content unit.

In general, in another aspect, the invention features a method including the steps of receiving an entertainment content unit from a entertainment content provider, receiving a plurality of advertising content units from one or more advertising content providers and generating a modified entertainment content unit by including a set of advertising content units at a plurality of intervals within the entertainment content unit. A request is received for the entertainment content unit from a consumer, and the modified entertainment content unit is sent to the consumer using transmissions over the Internet.

Implementations of the invention can include one or more of the following features. Generating a modified entertainment unit can be in response to receiving a request for the entertainment content unit from the consumer. Generating the modified entertainment content unit can include comparing target audience groups associated with the one or more units of advertising content to at least one of target audience groups associated with the entertainment content or audience groups associated with the consumer and selecting the set of advertising content units for generating the modified entertainment content unit based on the comparison. The modified entertainment content unit can be generated dynamically while transmitting the modified entertainment content unit to the consumer over the Internet.

The method can further include providing compensation to the entertainment content provider for the entertainment content unit and receiving compensation from the advertising content providers for including the set of advertising content units in the modified entertainment content unit, where the consumer is provided with the modified entertainment content unit on the recording medium at no monetary expense to the consumer.

In general, in another aspect, the invention features a method for providing entertainment content to a consumer. The method includes receiving a request from a consumer for a first entertainment content unit and providing the consumer a first modified entertainment content unit, the first modified entertainment content unit including the first entertainment content unit with a first set of advertising content units included at a plurality of intervals within the first entertainment content unit. A second request is received from the consumer for a second entertainment content unit, and feedback is requested from the consumer about the first modified entertainment content unit. The feedback is received from the consumer, and in response to receiving the feedback, the consumer is provided with a second modified entertainment content unit. The second modified entertainment content unit includes the second entertainment content unit with a second set of advertising content units included at a plurality of intervals within the second entertainment content unit. The consumer provides no monetary compensation in exchange for receipt of the first modified entertainment content unit and the second modified entertainment content unit.

Implementations of the invention can include one or more of the following features. Compensation can be provided to one or more entertainment content providers for the first and second entertainment content units, and compensation can be received from one or more advertising content providers for including the first and second sets of advertising content units in the first and second modified entertainment content units.

The first and second modified entertainment content units can be provided to the consumer on a first and second digital video disc (DVD) or a first and a second video tape. Alternatively, the first and second modified entertainment content units can be provided to the consumer by transmissions over the Internet.

The consumer feedback can be provided to at least one of an entertainment content provider or an advertising content provider. The method can further include receiving consumer feedback from a plurality of consumers, generating compiled consumer feedback by grouping the consumer feedback together for the first modified entertainment content unit, and providing the compiled consumer feedback to at least one of an entertainment content provider or an advertising content provider.

Implementations of the invention can realize one or more of the following advantages. Providing a modified entertainment content unit to a consumer free of charge may significantly increase the demand for the entertainment content unit, which can benefit entertainment content providers in at least two ways. First, an increase in viewership of an entertainment content unit, e.g., a fictional film, can increase the demand for related marketing paraphernalia, such as toys, clothing and the like, that is branded in connection with the film. Second, an entertainment content provider can benefit from increased license fees paid from the provider to the entertainment content provider if license fees are based on the number of entertainment content units distributed. Increasing the demand for the entertainment content unit can also provide an additional media for advertising content units to be presented to consumers.

The compensation received by the provider from the advertising content providers can exceed the compensation due from the provider to the entertainment content providers, resulting in an economically viable transaction from the perspective of a provider of the modified entertainment content unit. Additionally, the transaction is attractive to consumers, due to the receipt of the modified entertainment content unit free of charge; to the advertising content providers, who are provided with an additional advertising media; and to the entertainment content providers, who can receive compensation, e.g., a royalty, for distribution of entertainment content units that may have otherwise not been distributed (i.e., if not available for free from the provider, they may not have been purchased from the entertainment content provider).

Not only does a consumer receive the modified entertainment content unit free of charge, the consumer may watch the modified entertainment content unit at any time convenient to the consumer, without any time limitations (such as rental periods) and may watch the modified entertainment content unit more than once.

Selecting advertising content units tailored to a particular consumer or to one or more target audience groups of the entertainment content unit can increase the effectiveness of the advertising content units included in a modified entertainment content unit, providing an additional incentive to advertising content providers to pay to have their advertising content units included in the modified entertainment content unit. Additionally, because a consumer can pause, rewind and/or rewatch the modified entertainment content unit, including an advertising content unit of interest, a consumer can more easily make note of contact information for an advertiser included in an advertising content unit.

Providing a consumer with a free modified entertainment content unit in exchange for consumer feedback about a previously provided modified entertainment content unit gives the consumer an incentive to provide the consumer feedback, which can otherwise be difficult to elicit. Making consumer feedback information available to entertainment content providers and advertising content providers gives those parties an additional incentive to provide entertainment content units and advertising content units, respectively, to the provider.

The details of one or more embodiments of the invention are set forth in the accompanying drawings and the description below. Other features, aspects, and advantages of the invention will be apparent from the description and drawings, and from the claims.

### DESCRIPTION OF DRAWINGS

FIG. 1 shows schematic representation of a transaction for distribution of entertainment content.

FIG. 2 is a flowchart showing a process for providing a modified entertainment content unit to a consumer

FIG. 3 is a schematic representation of a system for generating and distributing a modified entertainment content unit.

FIG. 4 is a flowchart showing a process for selecting advertising content units to include in a modified entertainment content unit.

FIG. 5 is a flowchart showing a process for selecting advertising content units to include in a modified entertainment content unit.

FIG. 6 is a flowchart showing a process for obtaining consumer feedback from a consumer about an entertainment content unit and/or an advertising content unit.

FIG. 7 is a schematic representation of a DVD menu for a modified entertainment content unit.

Like reference symbols in the various drawings indicate like elements.

### DETAILED DESCRIPTION

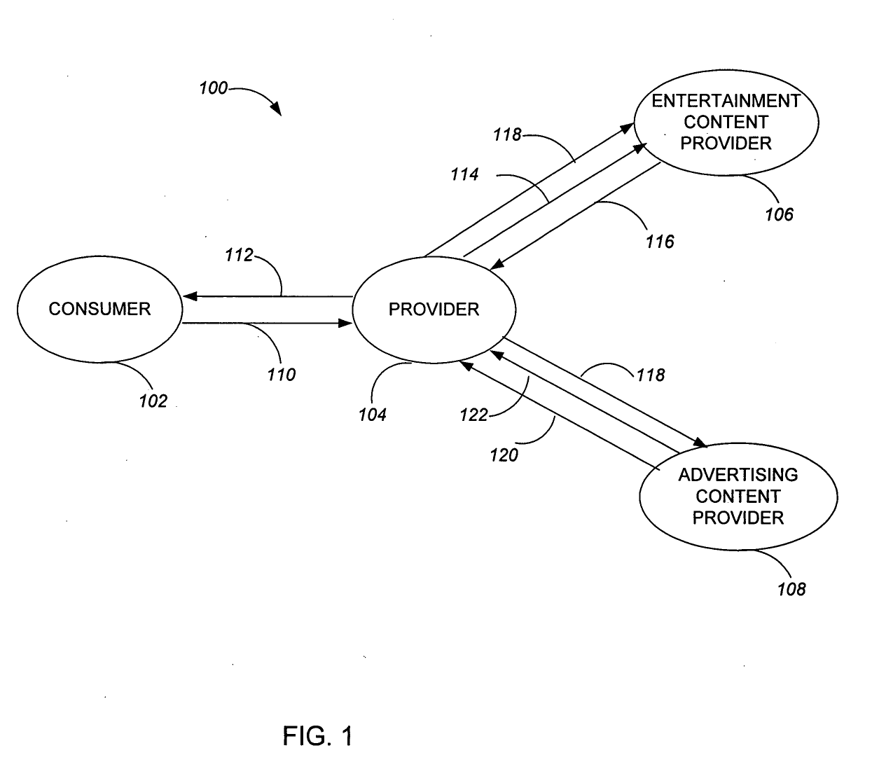

A method and system are described for providing entertainment content to a consumer. FIG. 1 shows a schematic representation 100 of a transaction between a provider 104 of the entertainment content to the consumer 102; a source of the entertainment content, an entertainment content provider 106; and a source of advertising content, an advertising content provider 108.

The entertainment content provider 106 provides entertainment content units 116 to the provider 104. An entertainment content unit 116 is content prepared to entertain or educate a viewer of the content, for example, a fictional or non-fictional film, or a program originally prepared for distribution by television. The entertainment content unit 116 is provided to the provider 104 in a format that can be used by the provider 104 to produce a modified entertainment content unit from the entertainment content unit 116. For example, the entertainment content unit can be provided as an electronic recording on a recording medium, such as a DVD or video tape, or can be transmitted over a network as an electronic file, for example, uploaded to the provider 104 over an Internet connection. Other forms of recording mediums can be used, and DVD and video tapes are merely exemplary mediums. The provider 104 may be required to enter an agreement, e.g., a license, with the entertainment content provider 106 to provide compensation 114 to the entertainment content provider 106 for the entertainment content unit 116, and to entitle the provider 104 to make modified reproductions of the entertainment content unit for distribution to one or more consumers 102.

One or more advertising content providers 108 provide advertising content units 120 to the provider 104. An advertising content unit 120 is a unit of advertising in a format that can be reproduced together with an entertainment content unit 116, for example, a still image advertising a product or service, or a brief video clip advertising a product or service, which may be similar to commercials aired on television. Additionally, an advertising content unit 120 can include contact information, e.g., a telephone number and/or web address, that a consumer can use to obtain more information from the advertiser. In one implementation, the advertising content unit 120 is provided as an electronic recording on a recording medium (e.g., DVD or video tape) or is transmitted over a network to the provider 104 as an electronic file. The provider 104 and the advertising content provider 108 may enter an agreement whereby the advertising content provider 108 entitles the provider 104 to reproduce the advertising content units 120 in combination with an entertainment content unit 116 for distribution to a consumer 102, and agrees to provide compensation 122 to the provider 104 for distributing the advertising content units 120 to one or more consumers 102.

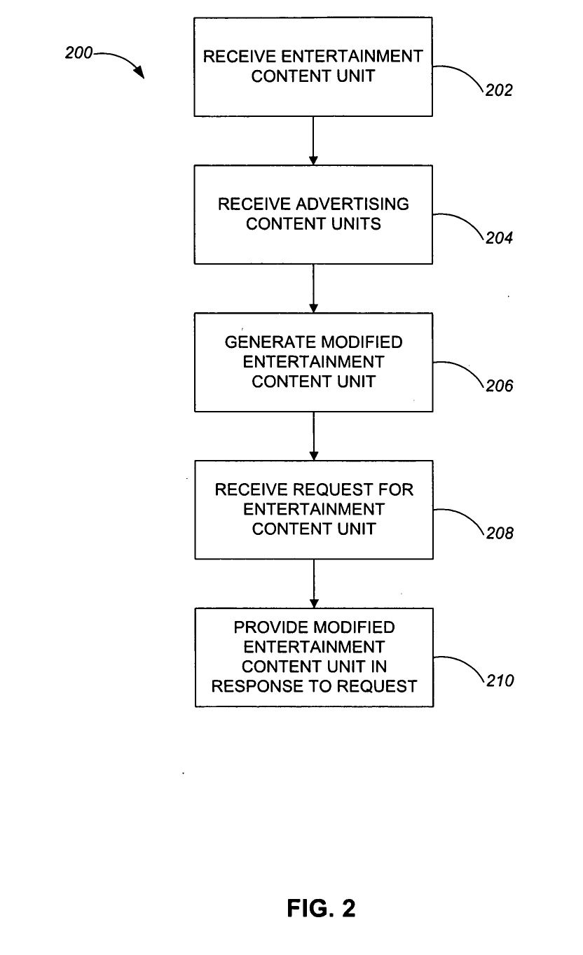

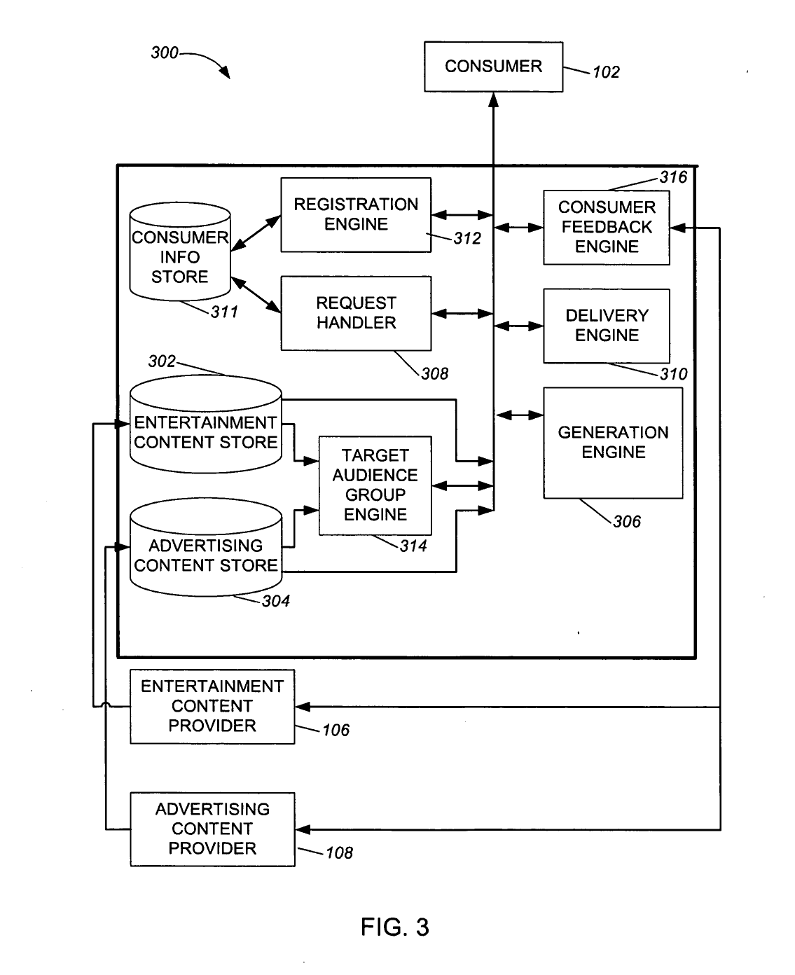

FIG. 2 shows a process whereby the provider 104 uses an entertainment content unit 116 and a set of advertising content units 120 to generate a modified entertainment content unit 112. The modified entertainment content unit 112 is provided to a consumer 102 in response to a request received from the consumer 102 for the entertainment content unit 116. The consumer 102 is not required to provide any monetary compensation to the provider 104 for the modified entertainment content unit 112, i.e., it is provided free of charge. FIG. 3 shows a schematic representation of a system 300 that can be used to generate the modified entertainment content unit 112.

The entertainment content unit 116 is received by the provider 104 from the entertainment content provider 106 (step 202). As mentioned above, the entertainment content unit 116 can be received on a recording medium or as an electronic file transmitted over a network. In one implementation, the entertainment content unit 116 is stored in an entertainment content store 302, e.g., a database. Advertising content units 120 are received by the provider 104 from one or more advertising content providers 108 (step 204). The advertising content units 120 can be received on one or more recording mediums or as one or more electronic files transmitted over a network. In the implementation depicted, the advertising content units 120 are stored in an advertising content store 304, e.g., a database.

A modified entertainment content unit 112 is generated from the entertainment content unit 116 and a set of advertising content units 120 (step 206). In one implementation, a generation engine 306 generates the modified entertainment content unit 112. The generation engine 306 can be implemented as a device capable of recording the entertainment content unit 116 and a set of advertising content units 120 together onto a recording medium or as an electronic file, whereby the set of advertising content units 120 are interspersed within the entertainment content 116 at numerous intervals. For example, in one implementation, the device is capable of executing scene detection software that can detect scene breaks within the content (e.g., film) forming the entertainment content unit 116. One or more advertising content units 120 from the set of advertising content units 120 are added to the entertainment content unit 116 at a number of the detected scene breaks. The resulting modified entertainment content unit 112 may resemble a television broadcast of a television program or movie that is interlaced throughout with a number of commercials.

In another embodiment, the generation engine 306 is a device capable of adding one or more advertising content units 120 from the set of advertising content units 120 at predetermined time intervals within the entertainment content unit 116. For example, an entertainment content unit 116 comprising a ninety (90) minute film can include one or more advertising units 120 after every 20 minutes of entertainment content, whether or not the advertising units 120 are interlaced into the entertainment content unit 116 at scene breaks.

The modified entertainment content unit 112, i.e., the recording of the entertainment content unit 116 interlaced with the set of advertising content units 120, can be recorded onto a physical medium, e.g., a DVD or videotape, for delivery to a consumer 102. Other forms of recording media can be used, and DVDs and videotapes are merely exemplary. Alternatively, the modified entertainment content unit 112 can be recorded as an electronic file in a format for transmission over a network to the consumer 102, e.g., over the Internet as a streamed or downloadable file, by FTP or as an e-mail attachment.

A request is received from the consumer 102 for the entertainment content unit 116 (step 208). For example, if the entertainment content unit 116 is a fictional film, the consumer 102 may request the film by title. In one implementation, a request handler 308 receives the request. For example, a request handler 308 can include a web site that displays to consumers 102 the available entertainment content units 116 and that is capable of receiving requests from consumers of selected entertainment content units 116, e.g., by a consumer using a mouse to click on a title or icon associated with an entertainment content unit 116. Alternatively, a request handler 308 can include a system that receives a request from a consumer for an entertainment content unit 116, for example, by telephone, facsimile, mail or e-mail, with or without a human operator.

In one implementation, before a consumer 102 is able to make a request for an entertainment content unit 116, the consumer 102 is required to provide consumer information, e.g., a name, address, e-mail address and the like. For example, a consumer 102 can provide the consumer information by registering at a web site from which a registered consumer 102 can request entertainment content units. A registration engine 312 can be implemented as an application executing on a web server that is operable to request, receive and record consumer information. Consumer information can be stored in a consumer information store 311.

In one implementation, a consumer 102 can search available entertainment content units 116 using a search engine on the provider's web site, for example, by key word searching or searching by category. In another implementation, a consumer 102 can make a request for entertainment content units 116 that are not yet available. For example, if a film was just released, or about to be released, in theatres, a consumer 102 can make a request that the corresponding modified entertainment content unit 112 be provided to the consumer 102 as soon as it becomes available, which could potentially be several weeks in the future. In another implementation, a consumer 102 can make a request for entertainment content units 116 of a certain category or genre that are not yet available, and perhaps not even yet known. For example, the consumer 102 can request that going forward a modified entertainment content unit 112 corresponding to every fictional film of a “romantic comedy” genre be provided to the consumer 102 as soon as such modified entertainment content unit 112 becomes available, even though the specific titles of such fictional films are not yet known to either the consumer 102 or the provider 104.

In response to the consumer's request for the selected entertainment content unit 116, the consumer 102 is provided with a corresponding modified entertainment content unit 112 (step 210). That is, if the consumer requests a fictional film entitled “The Great Film”, the consumer receives a recording of The Great Film with a set of advertising content units interspersed within The Great Film, e.g., at scene breaks or after preset time intervals. The consumer 102 is provided the modified entertainment content unit 112 free of charge. By contrast, if the consumer 102 wanted a recording of The Great Film without advertising content units 120 interspersed therein, the consumer 102 would typically have to purchase such a recording at the consumer's expense.

A delivery engine 310 is operable to cause delivery of the modified entertainment content unit 112 to the consumer 102. For example, if the modified entertainment content unit 112 is delivered on a physical medium, such as a DVD or video tape, a delivery engine 310 can include a device operable to print necessary mailing labels, and a human operator or machine may package the DVD or video tape, apply the mailing labels and deliver the package to a postal or courier service for delivery to the consumer 102. If the modified entertainment content unit 112 is delivered to the consumer 102 by the transmission of signals over a network, e.g., the Internet, the delivery engine 310 can include a server operable to stream an electronic file corresponding to the modified entertainment content unit 112 to a client computer designated by the consumer 102, or a server operable to upload the electronic file to the client computer.

The transaction described above can be more attractive to the advertising content providers 108 and potentially more satisfying for the consumers 102 if the set of advertising content units 120 included in the modified entertainment content unit 112 is tailored to a target audience for the entertainment content unit 116 or the actual audience, i.e., the consumer 102 that has requested the entertainment content unit 116.

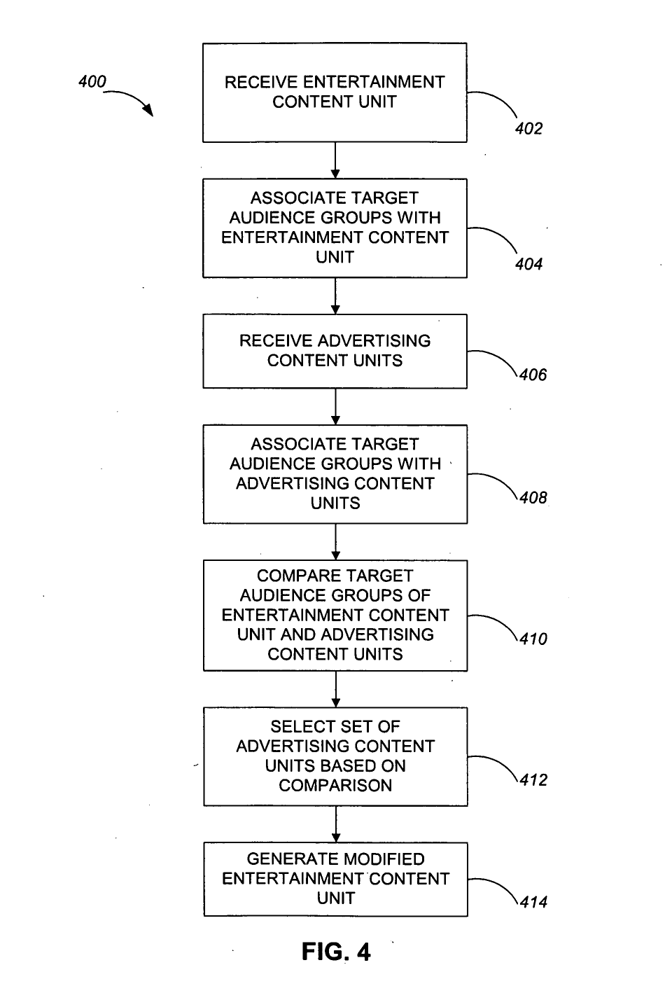

FIG. 4 shows a process 400 for one implementation of tailoring the set of advertising content units 120 to the target audience of the entertainment content unit 116. The provider 104 receives the entertainment content unit 116 (step 402) and associates one or more target audience groups with the entertainment content unit 116 (step 404). Target audience groups can be delineated taking into account one or more consumer characteristics, including, for example, age, gender, geographic location, languages spoken. By way of a simple example, consider target audience groups that are delineated solely by age as shown in the table below.

TABLE 1

| Target Audience Group # | Age Range | |
|---|---|---|
| 1 | 3-5 | years |
| 2 | 6-9 | years |
| 3 | 10-12 | years |
| 4 | 13-16 | years |
| 5 | 17-20 | years |
| 6 | 21-29 | years |
| 7 | 30-39 | years |
| 8 | 40-49 | years |
| 9 | 50-59 | years |
| 10 | 60+ | years |

Referring again to FIG. 3, a target audience group engine 314 can receive the entertainment content unit 116 from the entertainment content store 302, associate one or more target audience groups with the entertainment content unit 116 and provide an identifier of the associated one or more target audience groups to the generation engine 306. Additionally, the target audience group engine 314 can provide an identifier of the one or more associated target audience group to the entertainment content store 302 to store in association with the entertainment content unit 116. A subsequent retrieval of the entertainment content unit 116 from the entertainment content store 302 can thereby include the identifier(s) of the one or more associated target audience groups.

In one implementation, the provider 104 can request that the entertainment content provider 106 indicate the target audience group or groups that should be associated with the entertainment content unit 116. In another implementation, the provider 104 can have one or more persons view the entertainment content unit 116 and recommend one or more target audience groups. The target audience group engine 314 can assign an identifier of the one or more target audience groups to the entertainment content unit 116 based on either the target audience groups indicated by the entertainment content provider 106 or the recommendations of the one or more persons. Other techniques can be used. For example, in another implementation, a genre for the entertainment content unit can be determined, and the target audience groups associated with the entertainment content unit based on the determined genre. For example, if a genre of “romantic comedy” is determined, then it may follow that the associated target audience groups include groups #7-10 from Table 1 above.

Advertising content units 120 are received by the provider 104 from one or more advertising content providers (step 406) and one or more target audience groups are associated with each advertising content unit (step 408). In one implementation, the target audience group engine 314 can receive an advertising content unit 120 from the advertising content store 304, assign an identifier(s) of one or more target audience groups to the advertising content unit 120. Assigning one or more target audience groups to the advertising content unit 120 can be accomplished using the same or similar techniques to those described above in reference to the entertainment content unit 116. The target audience group engine 314 can provide the advertising content unit 120 and the identifier(s) of the one or more associated target audience groups to the generation engine 306. Additionally, the target audience group engine 314 can provide the identifier(s) of the one or more associated target audience groups to the advertising content store 304 to store in association with the advertising content unit 120. A subsequent retrieval of the advertising content unit 120 from the advertising content store 304 can thereby include the identifier(s) of the one or more associated target audience groups.

The set of advertising content units 120 to include with the entertainment content unit 116 in the modified entertainment content unit 112 is selected from the advertising content units 120 available in the advertising content store 304 (step 412). The selection of the set of advertising content units 120 is based on the one or more target audience groups associated with the entertainment content unit 116. For example, the one or more target audience groups assigned to the entertainment content unit 116 are compared to the target audience groups associated with the advertising content units 120 included in the advertising content store 304 (step 410), and only advertising content units 120 with one or more target audience groups matching those of the entertainment content unit 116 are selected. By way of illustration, if the entertainment content unit 116 is associated with target audience groups #3 and #4 shown in Table 1 above, then the set of advertising content units 120 is selected to include only advertising content units 120 that have been associated with either one or both of the target audience groups #3 and #4. The advertising content units 120 are thereby directed toward the same age group as the entertainment content unit 116, and are more likely to achieve a desired marketing objective.

In one implementation, the request handler 308 can pass the request for the entertainment content unit 116 to the target audience group engine 314. The target audience group engine 314 can retrieve advertising content units 120 from the advertising content store 304 that match the one or more target audience groups associated with the entertainment content unit 116 to compile the set of advertising content units 120. The target audience group engine 314 can then provide the entertainment content unit 116 and the set of advertising content units 120 to the generation engine 306. Alternatively, the request handler 308 can pass the request for the entertainment content unit 116 to the generation engine 306. The generation engine 306 can retrieve the entertainment content unit 116 from the entertainment content store 302, with the one or more target audience groups associated therewith, and select the set of advertising content units 120 from the advertising content store 304 based on the one or more target audience groups associated with the entertainment content unit 116.

The modified entertainment content unit 112 is generated from the entertainment content unit 116 and the set of advertising content units 120 (step 414). That is, the set of advertising content units 120 are interspersed within the entertainment content unit 116 at various intervals, which intervals can be defined, for example, by a preset time period or based on scene break detection.

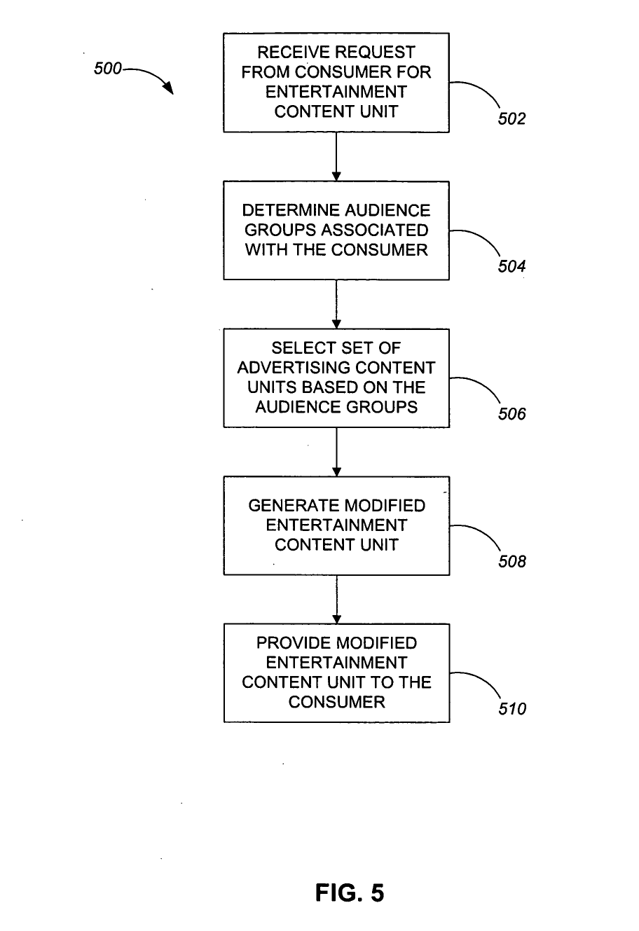

FIG. 5 shows an alternative process 500 for selecting the set of advertising content units 120 to include in the modified entertainment content unit 112, which is based on one or more target audience groups associated with the consumer 102 requesting the entertainment content unit 116. A request 110 is received from the consumer 102 for the entertainment content unit 116 (step 502). Audience groups associated with the consumer 102 are determined (step 504). In one implementation, consumer information provided by the consumer 102 upon registration with the registration engine 312 is retrieved from a consumer information store 311 to determine one or more audience groups associated with the consumer 102. The one or more audience groups associated with the consumer 102 are used to select the set of advertising content units 120 to include in the modified entertainment content unit 112 (step 506). For example, the request handler 308 can pass the request and an identifier(s) of the audience groups associated with the consumer 102 to either the target audience group engine 314 or the generation engine 306 for use in selecting the set of advertising content units 120.

The modified entertainment content unit 112 is generated from the entertainment content unit 116 and the set of advertising content units 120 (step 508), and is delivered to the consumer (step 510).

Determining the set of advertising content units 120 based on the consumer information can be useful if the consumer 102 is at least one person who views the modified entertainment content unit 112. However, in some circumstances a consumer 102 may request the modified entertainment content unit 112 for viewing by someone else, such as a child, in which case the set of advertising content units 120 selected based on the consumer information may be inappropriate. In one implementation, a consumer 102 can be asked at the time of making the request whether the modified entertainment content unit 112 is for their own use, and if not, then the consumer information is not used to select the set of advertising content units 120.

In one implementation, one advertising content provider 108 can sponsor a modified entertainment content unit 112, in that all advertising content units 120 included in the modified entertainment content unit 112 are from the one advertising content provider 108. Optionally, a header can be included at the beginning of the modified entertainment content unit 112 identifying the one advertising content provider 108 as the “sponsor”.

Optionally, lengthier advertising content units 120, e.g., descriptions of vacation packages or hotels, can be included at the end of the modified entertainment content unit 112 where they are available for viewing by an interested consumer 102, but do not distract from the flow of the modified entertainment content unit 116 by causing too lengthy of an interruption to the entertainment content.

In one implementation, consumer feedback can be obtained from consumers 102 to whom modified entertainment content units 112 have been provided about either or both of the entertainment content units 116 and the advertising content units 120. The consumer feedback can be provided to the entertainment content provider 106 and advertising content providers 108.

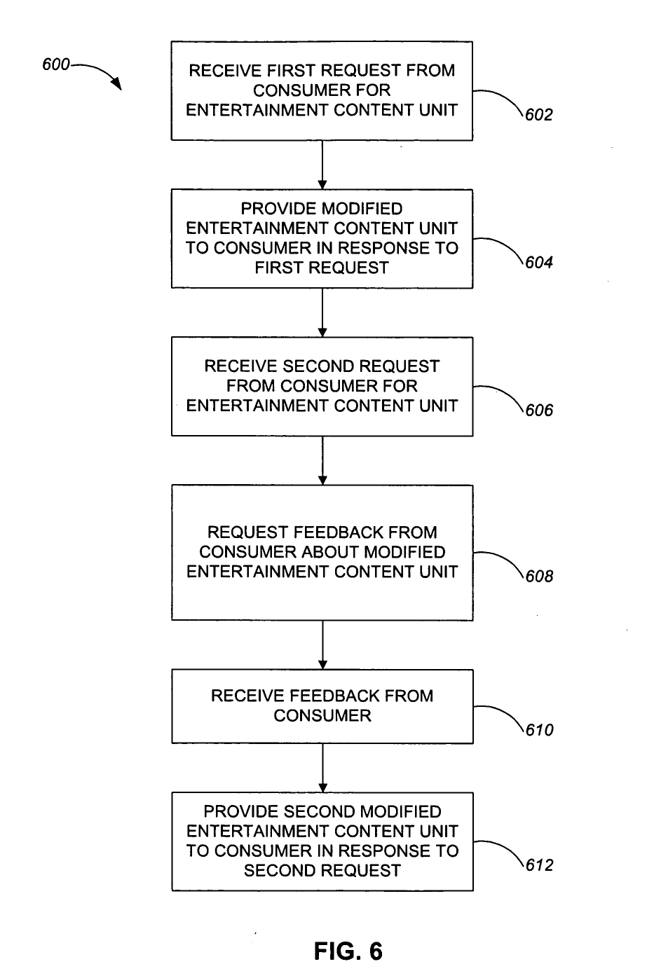

FIG. 6 shows one implementation of a process 600 for obtaining consumer feedback 110 from a consumer 102. An initial request is received from a consumer 102 for an entertainment content unit 116 (step 602). The provider 104 provides the consumer 102 with an initial modified entertainment content unit 112 in response to the initial request (step 604). At a later time, a second request is received from the same consumer 102 for a second entertainment content unit 116 (step 606). In response to the request, the provider 104 requests feedback from the consumer about the entertainment content unit 116 and/or one or more of the advertising content units 120 included in the initial modified entertainment content unit 112 provided to the consumer 102 in response to the initial request (step 608).

For example, if the consumer 102 makes the request for the second entertainment content unit 116 using a web site, the web site can present a web page to the consumer 102 with a consumer survey including various questions about the consumer's reaction to the modified entertainment content unit 116 previously provided to the consumer 102. Before the consumer 102 can continue with the process of requesting the second entertainment content unit 116, the consumer must complete the consumer survey. Other techniques can be used for gathering the consumer feedback 110. In one implementation, a consumer feed back engine 316 (shown in FIG. 3) requests and receives the consumer feedback 110 from the consumer 102.

The consumer feedback 110 is received from the consumer 102 (step 610) and the consumer 102 is provided with a second modified entertainment content unit 112 in response to the consumer's request for the second entertainment content unit 116 (step 612).

The consumer feedback 110 from the consumer 102 can be compiled with consumer feedback received from multiple other consumers 102 and the compilation of consumer feedback 118 provided to the appropriate party. That is, the compiled feedback 118 can be provided to an entertainment content provider 106 if the consumer feedback relates to an entertainment content unit 116, or to an advertising content provider 108 if the consumer feedback relates to an advertising content unit 120. The compiled consumer feedback 118 may be provided to an entertainment content provider 106 or advertising content provider 108 for a fee, as part of the consideration under the parties agreement to provide the entertainment content units 116 and advertising content units 120 to the provider 104, or for free as an incentive to continue providing the provider 104 with entertainment content units 116 and advertising content units 120.

In one implementation, the modified entertainment content unit 112 is provided to the consumer 102 by transmissions over a network, for example, by e-mail attachment, FTP, streaming or uploading over the Internet to a client computer designated by the consumer 102. In the case of streaming, the modified entertainment content unit 112 can be created dynamically as the modified entertainment content unit 112 is being streamed to the consumer 102. That is, a set of advertising content units 120 can be selected, which selection may be based on one or more target audience groups associated with the entertainment content unit 116 or one or more audience groups associated with the consumer 102. The advertising content units 120 can be selectively interspersed with the entertainment content unit 116 as the content is being streamed over the Internet to the consumer 102. In this implementation, a recording of the modified entertainment content unit 112 is not necessary, which can be particularly desirable when the modified entertainment content unit 112 is tailored specifically to the specific consumer 102 to whom it is being provided.

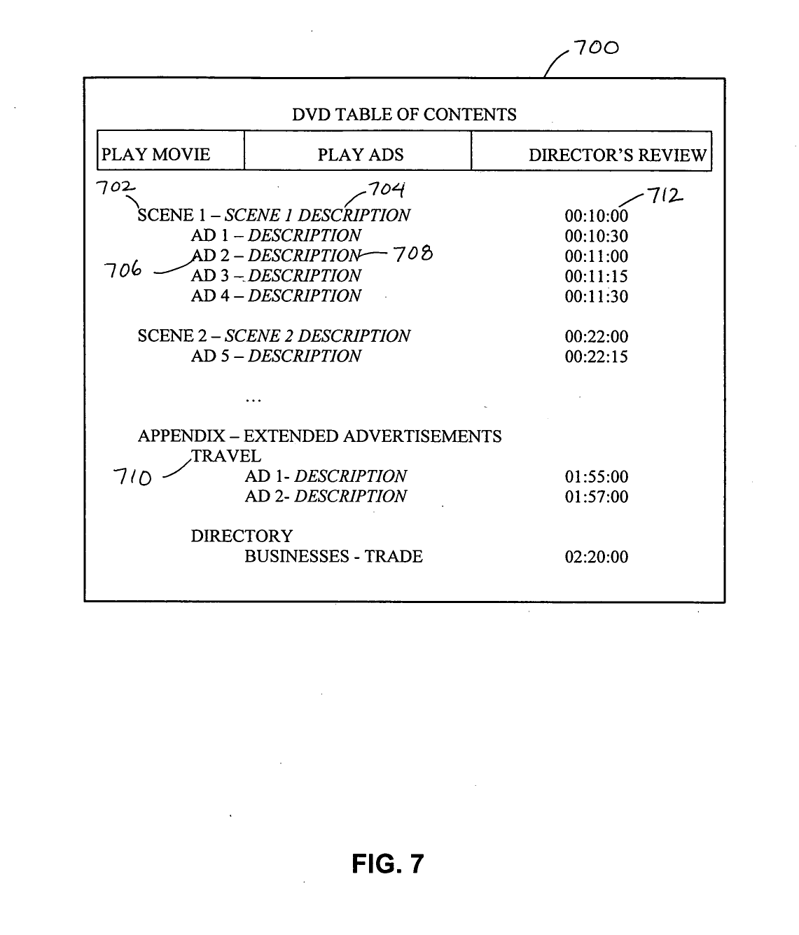

In one implementation, the modified entertainment content unit 112 is provided to the consumer 102 on an optical disk, such as a DVD. The DVD can include a table of contents or menu that allows the consumer 102 to select and view scenes of the entertainment content unit 116 or advertising content units 120 without having to view the entirety of the modified entertainment content unit 112. An exemplary DVD Table of Contents 700 is shown in FIG. 7. A listing of the scenes 702 including a descriptor 704 for each scene is included. A listing of the advertising content units 706, if any, included between scenes is also included, along with a descriptor 708 of each advertising content unit 120. The modified entertainment content unit 120 can optionally include an appendix with extended advertisements, and if so then a listing of the extended advertisements 710 is included. For example, extended advertisements can include lengthier descriptions of travel packages, or a directory of businesses that may be relevant to a viewer of the particular entertainment content unit 116 included on the DVD. An indication of where within the modified entertainment content unit 120, for example, the time of play as shown in a column 712 to the right of the descriptors, can also be included.

The processes for providing entertainment content to a consumer have been described above in relation to the system 300 shown in FIG. 3. However, the processes can be implemented using a different system, in particular a system with only some or none of the elements included in system 300, or including additional elements. The system 300 is an example of one system that can be used and is described for illustrative purposes only.

An engine, as the term is used throughout this application, can be a piece of hardware that encapsulates a function, can be firmware or can be a software application. An engine can perform one or more functions, and one piece of hardware, firmware or software can perform the functions of more than one of the engines described herein. Similarly, more than one piece of hardware, firmware and/or software can be used to perform the function of a single engine described herein.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers.

A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. The logic flows depicted in FIGS. 2 and 4-6 do not require the particular order shown, or sequential order, to achieve desirous results, and the steps of the invention can be performed in a different order. Accordingly, other embodiments are within the scope of the following claims.

What is claimed is:

1. A system for providing entertainment content to a consumer, comprising:
an entertainment content store storing a plurality of entertainment content units received from one or more entertainment content providers;
an advertising content store storing a plurality of advertising content units received from one or more advertising content providers;
a user interface operable to receive a request from a consumer for an entertainment content unit, the request identifying a first entertainment content unit stored in the entertainment content store;
a generation engine operable to generate a modified entertainment content unit by including a set of advertising content units at a plurality of intervals within the first entertainment content unit and recording the modified entertainment content unit on a recording medium; and
a delivery engine operable to cause the recording medium to be delivered to the consumer;
where the consumer does not provide monetary compensation to the system for providing the modified entertainment content unit, the system provides monetary compensation to the entertainment content provider of the first entertainment content unit, and the one or more advertising content providers that provided the set of advertising content units provide compensation to the system based on the delivery of the modified entertainment content unit to the consumer.

2. The system of claim 1, wherein the generation engine is further operable to generate the modified entertainment content unit in response to the request from the consumer for the first entertainment content unit.

3. The system of claim 1, wherein:
associated with the first entertainment content unit are one or more target audience groups;
one or more target audience groups are associated with each of the plurality of advertising content units stored in the advertising store; and the generation engine is further operable to:
compare the one or more target audience groups associated with the first entertainment content unit to the one or more target audience groups associated with each of the plurality of advertising content units stored in the advertising store; and
select the set of advertising content units to include within the first entertainment content unit based on the comparison.

4. The system of claim 1, further comprising:
a registration engine operable to receive consumer profile information from the consumer;
a target audience group engine operable to associate one or more audience groups with the consumer based on the consumer profile information and to associate one or more target audience groups with the plurality of advertising content units stored in the advertising store;
wherein the generation engine is further operable to:
compare the one or more audience groups associated with the consumer to the one or more target audience groups associated with the plurality of advertising content units stored in the advertising store; and
select the set of advertising content units to include within the entertainment content unit based on the comparison.

5. The system of claim 1, wherein:
the user interface is further operable to request feedback from the consumer about a previously delivered modified entertainment content unit and to receive the requested consumer feedback.

6. The system of claim 5, wherein the system is operable to provide the consumer feedback to at least one of an entertainment content provider or an advertising content provider.

7. The system of claim 5, wherein the system is further operable to compile consumer feedback received from a plurality of consumers and to provide the compiled consumer feedback to at least one of an entertainment content provider or an advertising content provider.

8. A system for providing entertainment content to a consumer, comprising:
a means for receiving an entertainment content unit from an entertainment content provider;
a means for receiving a plurality of advertising content units from one or more advertising content providers;
a means for generating a modified entertainment content unit by including a set of advertising content units at a plurality of intervals within the entertainment content unit;
a means for recording the modified entertainment content unit on a recording medium;
a means for receiving a request for the entertainment content unit from a consumer; and
a means for providing the consumer with the modified entertainment content unit on the recording medium;
where the consumer does not provide monetary compensation to the system for providing the modified entertainment content unit, the system provides monetary compensation to the entertainment content provider of the first entertainment content unit, and the one or more advertising content providers that provided the set of advertising content units provide compensation to the system based on the delivery of the modified entertainment content unit to the consumer.

9. The system of claim 8, wherein the recording medium is a digital video disc (DVD).

10. The system of claim 8, wherein the recording medium is a video tape.

11. The system of claim 8, further comprising:
a means for associating one or more target audience groups with the entertainment content unit; and
a means for associating one or more target audience groups with each of the plurality of advertising content units;
wherein a means for generating the modified entertainment content unit including a set of advertising content units included at a plurality of intervals within the entertainment content unit comprise:
a means for comparing the target audience groups associated with the entertainment content unit to the target audience groups associated with the plurality of units of advertising content units; and
a means for selecting the set of advertising content units from the plurality of advertising content units based on the comparison.

12. The system of claim 11, wherein a means for associating one or more target audience groups with the entertainment content unit comprise:
a means for determining a genre for the entertainment content unit; and
a means for associating the target audience groups based on the genre.

13. The system of claim 11, wherein a means for associating one or more target audience groups for the plurality of advertising content units comprise:
a means for receiving an association of one or more target audience groups to each of the plurality of advertising content units from the one or more advertising content providers.

14. The system of claim 8, further comprising:
a means for receiving from the consumer a consumer profile;
a means for associating one or more audience groups with the consumer based on the consumer profile; and
a means for associating one or more target audience groups with the plurality of advertising content units;
wherein a means for generating the modified entertainment content unit including a set of advertising content units included at a plurality of intervals within the entertainment content comprise:
a means for comparing the audience groups associated with the consumer to the target audience groups associated with the plurality of advertising content units; and
a means for selecting the set of advertising content units from the plurality of advertising content units based on the comparison.

15. The system of claim 8, wherein a means for generating a modified entertainment content unit including one or more advertising content units included at one or more intervals within the entertainment content unit comprise:
a means for detecting scene breaks within the entertainment content unit; and
a means for including one or more advertising content units of the set of advertising content units after one or more scene breaks.

16. The system of claim 8, wherein a means for generating a modified entertainment content unit including one or more advertising content units included at one or more intervals within the entertainment content unit comprise:
a means for including one or more advertising content units of the set of advertising content units after one or more predetermined time intervals of the entertainment content unit.

17. A method comprising:
receiving an entertainment content unit from an entertainment content provider;
receiving a plurality of advertising content units from one or more advertising content providers;
generating a modified entertainment content unit including a set of advertising content units at a plurality of intervals within the entertainment content unit;
recording the modified entertainment content unit on a recording medium;
receiving a request for the entertainment content unit from a consumer; and
providing the consumer with the modified entertainment content unit on the recording medium.

18. The method of claim 17, further comprising:
providing compensation to one of the entertainment content providers for the entertainment content unit; and
receiving compensation from one or more advertising content providers for including a set of advertising content units in the modified entertainment content unit;
wherein the consumer is provided with the modified entertainment content unit on the recording medium at no monetary expense to the consumer.

19. The method of claim 17, wherein generating the modified entertainment content unit is in response to receiving a request for the entertainment content unit from the consumer.

20. The method of claim 17, wherein the recording medium is a digital video disc (DVD).

21. The method of claim 17, wherein the recording medium is a video tape.

22. The method of claim 17, wherein the advertising content provider is not the entertainment content provider.

23. The method of claim 17, further comprising:
associating one or more target audience groups with the entertainment content unit; and
associating one or more target audience groups with the plurality of advertising content units;
wherein generating the modified entertainment content unit including a set of advertising content units at a plurality of intervals within the entertainment content unit comprises:
comparing the target audience groups associated with the entertainment content unit to the target audience groups associated with the plurality of advertising content units; and
selecting the set of advertising content units from the plurality of advertising content units based on the comparison.

24. The method of claim 23, wherein associating one or more target audience groups with the entertainment content unit comprises:
determining a genre for the entertainment content unit; and
associating the target audience groups based on the genre.

25. The method of claim 23, wherein associating one or more target audience groups with the plurality of advertising content units comprises:
receiving an association of one or more target audience groups with each of the plurality of advertising content units from the one or more advertising content providers.

26. The method of claim 17, further comprising:
receiving from the consumer a consumer profile;
associating one or more audience groups to the consumer based on the consumer profile; and
associating one or more target audience groups with the units of the plurality of advertising content units;
wherein generating the modified entertainment content unit including a set of advertising content units at a plurality of intervals within the entertainment content unit comprises:
comparing the audience groups associated with the consumer to the target audience groups associated with the plurality of advertising content units; and
selecting the set of advertising content units from the plurality of advertising content units based on the comparison.

27. The method of claim 17, wherein generating a modified entertainment content unit including a set of advertising content units included at a plurality of intervals within the entertainment content unit comprises:
detecting scene breaks within the entertainment content unit; and
including the one or more advertising content units of the set of advertising content units after a plurality of scene breaks.

28. The method of claim 17, wherein generating a modified entertainment content unit including a set of advertising content units included at a plurality of intervals within the entertainment content unit comprises:
including one or more advertising content units of the set of advertising content units after a plurality of predetermined time intervals of the entertainment content unit.

29. A method comprising:
receiving an entertainment content unit from a entertainment content provider;
receiving a plurality of advertising content units from one or more advertising content providers;
generating a modified entertainment content unit by including a set of advertising content units at a plurality of intervals within the entertainment content unit;
receiving a request for the entertainment content unit from a consumer; and
sending the modified entertainment content unit to the consumer using transmissions over the Internet.

30. The method of claim 29, wherein generating a modified entertainment unit is in response to receiving a request for the entertainment content unit from the consumer.

31. The method of claim 29, wherein generating the modified entertainment content unit including a set of advertising content units at one or more intervals within the entertainment content unit comprises:
comparing target audience groups associated with the one or more units of advertising content to at least one of target audience groups associated with the entertainment content or audience groups associated with the consumer;
selecting the set of advertising content units for generating the modified entertainment content unit based on the comparison; and
generating the modified entertainment content unit dynamically while transmitting the modified entertainment content unit to the consumer over the Internet.

32. The method of claim 29, further comprising:
providing compensation to the entertainment content provider for the entertainment content unit; and
receiving compensation from the advertising content providers for including the set of advertising content units in the modified entertainment content unit;
wherein the consumer is provided with the modified entertainment content unit on the recording medium at no monetary expense to the consumer.

33. A method for providing entertainment content to a consumer, comprising:
receiving a request from a consumer for a first entertainment content unit;
providing the consumer a first modified entertainment content unit, the first modified entertainment content unit including the first entertainment content unit with a first set of advertising content units included at a plurality of intervals within the first entertainment content unit;
receiving a second request from the consumer for a second entertainment content unit;
requesting feedback from the consumer about the first modified entertainment content unit;
receiving the feedback from the consumer; and
in response to receiving the feedback, providing the consumer with a second modified entertainment content unit, the second modified entertainment content unit including the second entertainment content unit with a second set of advertising content units included at a plurality of intervals within the second entertainment content unit;
wherein the consumer provides no monetary compensation in exchange for receipt of the first modified entertainment content unit and the second modified entertainment content unit.

34. The method of claim 33, further comprising:
providing compensation to one or more entertainment content providers for the first and second entertainment content units; and
receiving compensation from one or more advertising content providers for including the first and second sets of advertising content units in the first and second modified entertainment content units.

35. The method of claim 33, wherein the first and second modified entertainment content units are provided to the consumer on a first and second digital video disc (DVD).

36. The method of claim 33, wherein the first and second modified entertainment content units are provided to the consumer on a first and a second video tape.

37. The method of claim 33, wherein the first and second modified entertainment content units are provided to the consumer by transmissions over the Internet.

38. The method of claim 33, further comprising:
providing the consumer feedback to at least one of an entertainment content provider or an advertising content provider.

39. The method of claim 33, further comprising:
receiving consumer feedback from a plurality of consumers;
generating compiled consumer feedback by grouping the consumer feedback together for the first modified entertainment content unit; and
providing the compiled consumer feedback to at least one of an entertainment content provider or an advertising content provider.
